(19) United States
(12) Patent Application Publication
(10) Pub. No.: US 2006/0173770 A1
(43) Pub. Date: Aug. 3, 2006

(54) Telephony controlled auction

(76) Inventors: Anthony McKay, Hemel Hempstead (GB); Bill Burgar, Hemel Hempstead (GB); Craig Scott, Wilberfoss (GB)

Correspondence Address: STETINA BRUNDA GARRED & BRUCKER, 75 ENTERPRISE, SUITE 250, ALISO VIEJO, CA, 92656, US

(21) Appl. No.: 11/046,973

(22) Filed: Jan. 31, 2005

(51) Int. Cl. G06Q 40/00

(52) U.S. Cl. 705/37

(57) ABSTRACT

An online auction such as Ebay is provided with a telephone interface. This allows buyers, sellers or auction watchers to receive spoken information describing the auction progress and also allows bidding by telephone using speech and/or DTMF. Reminders may also be issued when a certain bid price has been reached and/or as the auction reaches its closing stages. The Interface provides far greater access to an auction than is otherwise possible. This is advantageous to the auction operator and buyers and sellers.

### FIELD OF THE INVENTION

The invention relates to a real time telephone interface onto an on-line auction system such as eBay.

### BACKGROUND OF THE INVENTION

The online auction phenomenon is revolutionising the way people buy and sell goods. The ‘auction house’ (eBay, QXL, uBid, Yahoo etc.) will typically charge a percentage of the sale price as its fee. Hence, it is in everyone's interest (except the buyer) to have a high sale price. Increasing the number of buyers competing for an item is a good way to increase the resultant sale price.

Whereas a ‘real’ auction begins at a specific time and runs until there are no more bids, an on-line auction is usually different. An on-line auction will begin immediately and start dosing at a fixed, pre-defined, time. Occasionally, online auctions mimic real auctions by having a closing criteria such as a recorded minimum time and a time window during which no bids have been received. Since most of the significant bids happen towards the end of an auction, it important that people are aware that an auction is closing and are in a position to place a bid. For most people, this means being in front of a computer with an Internet connection and a web browser at the correct time. This is not always possible or convenient.

There are existing mechanisms that attempt to address the issue of accessibility such as automatic proxy bidding, SMS bidding, WAP bidding and e-mail bidding. These all have their drawbacks, mainly due to their inflexibility, complexity and latency. Latency (the speed with which a user may be notified of a new bid price and then place a counter bid) is crucial to the success of the buyer since most bids occur in the final minutes of the auction.

Where SMS bidding is employed, an ‘out bid’ message must be sent to all interested parties each time a bid is exceeded. This can be expensive for the recipient as they usually pay for each message received. The sheer load placed upon the SMS infrastructure may also increase the message delivery latency.

There are existing mechanisms that attempt to inform potential purchasers when an auction is entering its closing stages. These tend to rely on ‘messaging’ (e-mail or SMS.) Both of these mechanisms are not real-time and can be subject to significant latency. In addition, both require a specialised device to receive the message (an e-mail client connected to the Internet or mobile phone.)

### SUMMARY OF THE INVENTION

The system described below is a real time telephone interface onto an on-line auction system such as eBay. It allows callers to bid for goods at an auction by using a telephone. It provides increased access to auctions for potential buyers.

In a first aspect of the invention there is provided control apparatus for an electronic auction system comprising, a telephony interface for connection to a voice or data network, an auction interface for connection to an electronic auction system and an auction manager arranged to receive user commands via the telephony interface, to receive auction information via the auction interface, to relay auction information to the telephony interface and to relay user commands to the auction interface.

Providing live telephone access to the bidding process solves or mitigates the problems noted above in connection with the prior art.

In another aspect there is provided a method of interacting with an auction comprising receiving bid commands from a user via a speech or DTMF interface, interpreting the commands, relaying the bid commands to an electronic auction system, receiving auction information from the electronic auction system and relaying auction information back to the user in the form of machine-generated spoken information.

In a further aspect, there is provided a computer program which when operated on suitable hardware causes the hardware to be operable to receive bid commands from a user via a speech or DTMF interface, interpret the commands, relay the bid commands to an electronic auction system, receive auction information from the electronic auction system and to relay auction information back to the user in the form of machine-generated speech.

In an additional aspect, the invention provides a method of generating revenue from an auction comprising providing a real-time telephony interface to an electronic auction which accepts speech and/or DTMF commands and charging the auction provider and/or auction user for the provision of the speech or DTMF connection.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

FIG. 1 is a schematic diagram of an auction system in accordance with the invention.

### DETAILED DESCRIPTION OF THE PREFERRED EMBODIMENTS

For the purposes of this description, the terms “machine-generated speech”, “machine-generated spoken information” and its equivalents should be taken to mean artificially generated speech which may include digitally recorded words assembled into sentences and may included voice sounds which are machine-assembled into word sounds.

The term “voice” should be taken to include TDM-type voice connections and also digitised voice connections such as voice-over-IP.

The term ‘online auction’ should be taken to include an Internet based auction such as Ebay but may be taken more generally to include any auction controlled and operated by computer without a human auctioneer and contactable by electronic means. This may, for example, include auctions operated on private data networks.

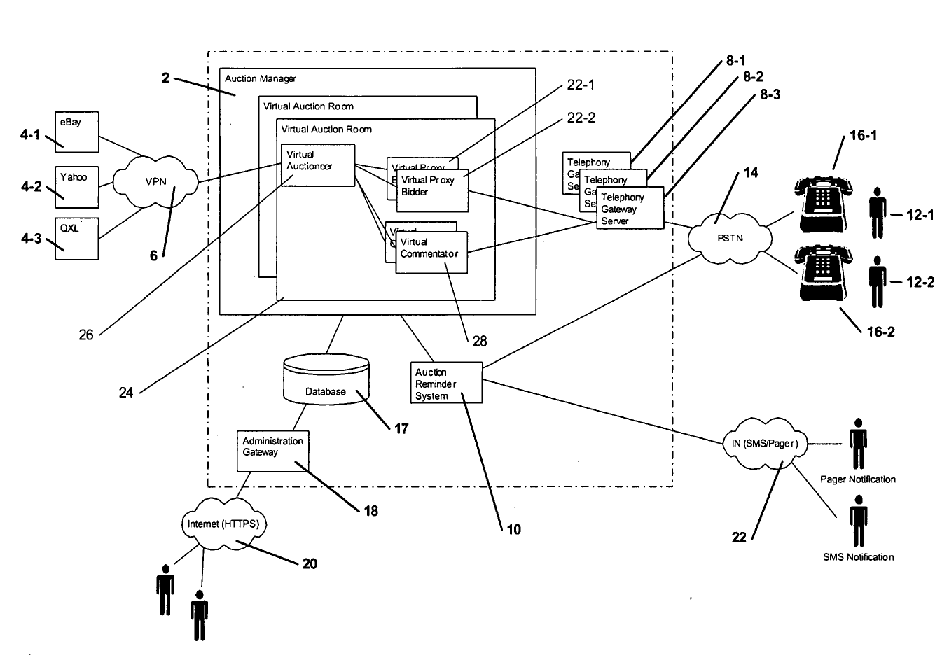

FIG. 1, provides a high level view of the logical components that make up a telephone interface in accordance with the invention.

An auction manager 2 acts as a layer of abstraction, which allows the rest of the system to interoperate with online auction engines 4-1 to 4-3 from multiple vendors. The auction engines 4-1 to 4-3 may be coupled to the auction manager 2 via an Internet Protocol Virtual Private Network (VPN) 6. The auction manager 2 is arranged to manage multiple auctions from multiple online vendors simultaneously. It transmits auction commands via the network 6 and receives information about the progress of an auction.

The auction manager 2 also coordinates and controls the other functions of the invention many of which are delegated to the structures describe in detail below. In particular, the auction manager 2 manages the relationship between a telephone caller and an associated online auction ID. It places bids on behalf of callers, which are received via telephony gateway servers 8-1 to 8-3. It provides up-to-date information for the telephony gateway servers to give to callers 12-1 to 12-2 and it provides up to date information for an Auction Reminder System 10.

The detailed operation of the system is described below but in general terms, callers 12-1 to 12-2 interact with the auction manager 2 via the public services telephone network (PSTN) 14. The auction manager manages a series of virtual auction rooms 24 each of which is associated with a single item (or occasionally a linked set of items) which is being auctioned. Caller interaction occurs via respective telephones 16-1 to 16-2. The telephones 16-1 to 16-2 may be any telephone handset including but not limited to, mobile or cellular telephones and fixed landline handsets. The minimum feature set typically is a voice output capability and a DTMF and/or voice input capability. Thus the handset may, for example, be a handsfree car kit for a mobile telephone.

In use, the system provides greatly improved accessibility. Most people have access to a telephone wherever they are—and a telephone is all that is needed to participate in an auction. Callers can interact with the system by DTMF or spoken command (allowing hands free bidding for drivers etc.) By increasing accessibility, more people will participate in more auctions more of the time.

Because the system operates in real-time, bidders are able to exercise a greater degree of control over when and what bid is submitted—there is no ‘lag’, which is a consistent feature of most other mechanisms. Therefore, the rate of bidding can be greatly increased, which is especially relevant near the end of an auction.

The system is interactive and constantly updates the caller with the status of the bidding and encourages the caller to increase their bid. This will be fun and exciting for the caller with a ‘competition’ type atmosphere (reflected in the tone and pace of the system voice).

The system may also be proactive. This may be achieved by the system attempting to contact all interested parties to giving them the opportunity to make a last minute bid, a short time before the auction is due to close,

The detailed structure and operation of the system will now be described.

Telephony Gateway Server

A telephony gateway server 8-1 to 8-3 contains the necessary hardware to terminate telephone calls (iSDN, Analogue, IP etc), play speech to the caller and recognise both speech and DTMF input. The sever interacts with the callers 12-1 to 12-2, giving them the latest information about an auction and placing bids on their behalf using the Auction Manager 2. There can be any number of these servers depending upon call volume requirements. Each telephony gateway server 8-1 to 8-3 is arranged to terminate telephone calls, identify and authenticate callers, provide callers with the latest information (using a mixture of machine generated speech and pre-recorded speech) and to recognise and act upon caller requests and commands whether issued by speech and/or DTMF.

Auction Manager

The auction manager 2 manages the relationship between the caller on the telephone and their on-line presence in the auction. It provides auction status information to be ‘rendered’ to the caller by the hardware in the telephony gateway server and it accepts commands from the caller as interpreted by the telephony gateway server 8-1 to 8-3. Logically each caller interacts with a respective virtual proxy bidder 22-1 or 22-2. The proxy bidder is present in a virtual auction room 24 along with the proxies for other callers bidding for the same items. Also present in the virtual auction room 24 is a virtual auctioneer 26, which relays bids and auction status between the online auction 4-1 to 4-3 and the proxies 22-1 or 22-2 and hence to the callers 12-1 or 12-2. Thus each item or linked set of items being auctioned has a respective auction room 24 and auctioneer 26. Each caller has a respective proxy bidder 22-1 or 22-2.

Typically, the proxy bidder 22-1, 22-3 will attempt to draw a user into the auction and cause them to remain connected. As explained below, this may be achieved, for example, by providing a tense atmosphere and providing information about the auction progress in the form of updates about closing time, the current bid price and/or the number of other bidders

Auction Reminder System

The auction reminder system 10 attempts to contact registered users to notify them that an auction is entering its closing stages. It is arranged to identify when auctions for which there are interested parties enter their closing stages and to hunt for those interested parties (by calling multiple numbers, SMS/Pager etc.)

Database

All persistent data such as user credentials, account information, reminder contact details and call records are stored in a central database 17 coupled to the auction manager. Even ‘volatile’ information such as the current bid price is stored in the database 17 to allow centralised access by all the other interested components of the system.

The database 17 may also be arranged to map a caller to an online auction ID stored in the database. It may also store authentication details such as personal identification numbers (PINs) and/or passwords for both the telephone interface system and a relevant online auction system 4-1 to 4-3. The database may also carry a biometric voice print of a registered user. This may be used for authentication purposes.

The database 17 also stores non-authentication information such as account information to enable the telephone interface system to make charges to the users, contact details such as contact telephone numbers which may be used by the Auction Reminder System 10 and call records detailing each interaction with the system which may be used for audit purposes.

Administration Gateway

This is typically a web server 18 providing an interface onto the database 17 via an encrypted Internet link 20. The gateway allows users to register with the system as described below, and to manage their account, Auction Reminder System settings, and log on details (PIN etc) and to view a time stamped report of any of their previous interactions with the system.

Integration With Existing Auction Services

The telephone interface system Is an extension to an online auction service such as that presently provided by Ebay. The system may require additional registration information. It can be linked by a fast, real-time data connection 6 to the auction engine 4-1 to 4-3 or it may use a combination of email and real-time links. There is a middleware ‘abstraction’ layer 2 making it possible to integrate with practically any online auction engine.

The telephone interface service can either be deployed as a totally separate service or it can be seamlessly embedded in the host auction site—complete with host branding etc. Typically it will be advertised on the host auction web site.

In order to participate in an auction, a user typically will need to undertake the following steps:
Registration
Joining an auction
Bidding
Administration—making payments, topping up payments etc.

These steps are described in detail below.

Registration

Depending upon the level of integration with the host auction site, the user will either indicate their desire to perform telephone bidding whilst registering (or at a later time) with the host online auction or will register separately with the an affiliated telephone-booking site by supplying the relevant host auction site registration details—user name, password etc.

In addition, the applicant will typically provide a PIN to be to authenticated for telephone bids and optionally, one or more telephone contact numbers (and the order in which they should be tried) for use with the reminder system 10.

The applicant may also create a calling card account, which is used to fund any direct telecoms costs such as reminder calls and SMS/Pager notifications.

As a further enhancement, the applicant may provide a biometric ‘voice print’ for increased security on large purchases as discussed below. As noted above, the voiceprint is typically stored in the database 17.

Joining An Auction

Proactive Call

Once registered, potential buyers may call a central number to take part in an auction. Once identified and authenticated, the caller will be asked to choose an auction to join. Once chosen, confirmation of the item being auctioned, current bid price and auction close time will be given by machine-generated speech. The buyer can then stay on the line in order to participate in the auction (or just hang up.)

If a person makes repeated calls and their last chosen auction is still active then, as an optimisation, they will be offered this auction as default. This saves the caller from having to specifically choose an auction each time. This assumes that most people are only interested in a single item.

The Auction Reminder System (ARS)

Since most bidding takes place during the closing minutes of an auction and an auctions closing time may be days in the future, it is important for potential buyers to be reminded when an auction enters its closing stages.

The ARS 10 ensures that buyers are automatically contacted at appropriate times in order to let them partake live in an auction.

The ARS 10 is not only for buyers, it may also be used by sellers and other interested parties.

The ARS 10 may attempt to contact a registered user by one or more of the following mechanisms:
1. Calling one or more of the users telephone contacts (home, mobile etc.) in the users pre-defined order (‘Call-back Reminders’.)
2. Sending an SMS to the user.
3. Sending a pager message to the user.

Call-Back Reminders

The ARS can be configured to call each registered user a configurable period prior to closure of the auction. In this case, the ARS 10 attempts to locate potential buyers by trying each of their registered contact numbers (in their registered order).

Where an answer machine is detected, the system will attempt to leave a message (and hunt on as necessary.)

Once contact has been made, and the buyer identified and authenticated, the system will announce the details of the item being auctioned, current bid price and auction close time. The buyer can then stay on the line in order to participate in the auction (or just hang up.)

Where contact has been made to a buyer on a cellular phone, the system will automatically re-establish a connection to that phone should the call terminate unexpectedly.

If an interested party cannot be reached, the ARS 10 will optionally retry at a later time.

A maximum bid price threshold can also be set, above which the ARS10 will not attempt to locate the buyer.

If a caller has registered for a callback for more than one auction and the auctions coincide, the system will interrupt the first callback with the second, allowing the buyer to toggle between the two auctions.

SMS/Pager Reminders

Alternatively (or additionally) the ARS 10 may send an SMS/Pager message via an SMS or pager network 22. The message provides details of the item being auctioned, current bid price and auction close time.

Anonymous Interest (Virtual Commentator)

Just as with the standard online service, it is possible for an unregistered person to call in, select an item and listen in on the auction. Such a user is not able to interact in with the auction but is able to listen to a running commentary. No identification or authentication is necessarily required.

Access to this service may be via the same number as for registered users or from a separate number specifically for the purpose.

If a person, as identified by their calling number, makes repeated calls and their last chosen auction is still active then, as an optimisation, they will be offered this auction as default. This saves the caller from having to specifically choose an auction each time. This assumes that most people are only interested in a single item.

These calls are dealt with by a virtual commentator 28 logically associated with the relevant virtual auction room 24.

Identification and Authentication

Since the system enables people to conduct real financial transactions, security is extremely important.

At the point of registration, users are asked to supply a PIN and in exchange will be allocated a user ID. This information is stored in the database 17.

A user is not granted access to any information or bidding functionality until successful identification and authentication has occurred. If a user has called in using (or been called back on) their cellular phone they will, optionally, not be asked to identify themselves. This is an optimisation based on the assumption that a cellular phone belongs to a single individual and therefore identifies the individual.

Several typical identification/authentication mechanisms may be used. For example, for relatively low value goods, a simple PIN entry system is sufficient. The caller is asked to supply their user ID and PIN.

For higher value goods, an additional level of security can be invoked such as speaker verification. This is similar to the simple PIN mechanism except that as part of the registration, a user will be required to enroll with the system by providing a biometric voiceprint. This is used as an additional authentication method. Not only will a caller need to know the PIN but they will also need to have a voiceprint match.

Identification and authentication can be performed by DTMF (pressing buttons on a telephone) or by spoken command (speech recognition).

Bidding

One significant advantage of the telephone user interface described herein, is its continual, near real-time feedback of the status of the auction—wherever a user is located. This may include current bid price, time left, number of other buyers interested in the item etc. When this information is combined with an enthusiastic ‘voice’ provided by the telephony gateway server 8-1 to 8-3, the whole experience should be both efficient and exhilarating.

As with most online auctions, the buyer will have the option of either entering their new bid as an absolute sum or just defaulting to the next minimum increment (as usually defined by the online auction engine.)

Callers are kept continuously informed of the current highest bid, time remaining and number of other people currently showing interest in the item for sale.

Bidding can be enacted by DTMF (pressing buttons on a telephone) or by spoken command (speech recognition).

It is possible to bid in multiple auctions simultaneously. Callers are able to toggle between the auctions and the auctions in-turn will interrupt each other as their status changes.

The interface is designed to give, as near real-time feedback as possible. However, due to the serial nature of speech, it takes a finite amount of time to read out the information: during which time the information may change. Real auctioneers deal with this issue by interrupting themselves. The frequency with which these interruptions occur indicates to buyers the level of competition.

The interface emulates this behaviour. As it nears the end of the auction and the bids change more frequently, the proxy bidder 22-1,22-2 interrupts itself more frequently thus giving more real time feedback and a real sense of the competition involved. However, the frequency with which the interruptions occur may not be dictated solely by the frequency with which the information changes. The interruption frequency may be artificially adjusted based on remaining time before the auction closes. The closer to the end of the auction; the more frequently interruptions will occur. This creates a measured and increased sense of urgency.

Once the proxy bidder starts to interrupt itself frequently, the generated speech may also be arranged to change from a relatively sedate, unemotional tone to a more urgent emotional tone. Further increasing the competitive atmosphere.

Example Voice Interactions

The system generated voice statements (typically initiated and controlled by the proxy bidder 22 and rendered by the gateway 8) are shown in bold and the user inputs may be given via a voice recognition system and/or via DTMF signalling, for example. Dots (“ . . . ”) indicate the passage of time.

A Buyer Calls ‘Proactively’ 2 Minutes Before the Close of an Auction for a Digital Camera.

Good afternoon, please enter your user ID”

‘12468’

“Please enter digit 3 and 6 from your PIN”

“23”

“Please enter the item number that you would like to bid for”

“6709697311”

“You have selected a Pentax Optio 4MegaPixel Digital camera. Current bid price is £250. This auction closes in approximately two minutes at 4 pm. To bid £260 press #”

“#”

“You now have the highest bid at £260”

. . .

“The auction closes in approximately one and a half minutes at 4 pm”

. . .

“You have the highest bid at £260, to ret . . . ” <system interrupts itself>

. . .

“You have just been out bid, the new bid price is £270. To bid £280 press #”

. . .

“The auction closes in approximately 1 minute at 4 pm. To bid £280 press #”

. . .

“There are at least 5 more people interested in this item. To bid £280 press #”

. . .

“To bid £280 press #, the auction closes in 10 . . . 9 . . . 8 . . . 6 . . . ”

“#”

“You now have the highest bid at £280. The auction closes in 3 . . . 2 . . . 1”

. . .

“The auction is now closed. Congratulations, your bid was the highest”

The ARS 10 Calls a Buyer 2 Minutes Before the Close of an Auction for a Digital Camera.
<ring ring>
“Hello”

“Good afternoon, this a reminder call from eBay. Please enter your user ID”

“12468”

“Please enter digit 3 and 6 from your PIN”

“23”

“You have selected a Pentax Optio 4MegaPixel Digital camera. Current bid price is £250. This auction closes in approximately two minutes at 4 pm. To bid £260 press #”

“#”

etc . . .

The Seller Calls in to Check the Status of the Sale

“Good afternoon, please enter your user ID”

“12468”

“Please enter digit 3 and 6 from your PIN”

“23”

“Please enter the item number that you would like to bid for”

“6709697311”

“You have selected a Pentax Optio 4MegaPixel Digital camera. Current bid price is £250. This auction closes in approximately two minutes at 4 pm. To bid £260 press #”
<caller hangs up>
. . .
<calls back in sometime later>

“Good afternoon, please enter your user ID”

“12468”

“Please enter digit 1 and 2 from your PIN”

“12”

“Please enter the item number that you would like to bid for or press * for the Pentax Optio 4MegaPixel Digital camera that you last selected”

“*”

“Current bid price is £250. This auction closes in approximately one minute at 4 pm. To bid £260 press #”
<caller hangs up>

Financial Model

There are several ways that revenue may be generated. Some examples are given below.
1. Proactive callers may call a revenue sharing number (e.g. an 087x number in the UK). Different numbers may be used for different types of caller or auction depending upon the value of the caller or the goods.
2. A percentage of the ARS call back costs may be deducted from a user's ‘Calling Card’ account, which is set up at registration time.
3. A fixed price charge may be made for using the telephone bid capability. The payment may be made using PayPAL, reverse charge SMS or deducted from the ‘Calling Card’ account, of example.
4. A percentage of the sale price may be taken when an item is secured using the telephone interface of the present invention.

Key Architectural/Process Elements

These are summarised below, by way of example. It will be appreciated by those skilled in the art that functional elements may be chosen to be associated with particular hardware elements according to typical design constraints such as data bandwidth, processing power, power supply and heat considerations. Thus the associations noted below may be freely varied without departing from the spirit and scope of the invention;
1. Telephony Gateway Server(s). These have limited intelligence and merely terminate the telephone calls and act as the mouth and ears of the system, reading out information and recognising spoken/DTMF input.
2. Auction manager(s). These are the ‘brains’ of the system. They maintain the link between the caller and their on-line auction presence. They use the Telephony Gateway Servers to interface to the caller. Internally, they maintain the following logical components:
   a. Multiple virtual auction rooms (one for each item being bid for.)
   b. Single virtual auctioneer per virtual auction room placing the bids and retrieving the auction status from the online auction. The virtual auctioneer is party to all the bids in the auction.
   c. Multiple virtual proxy bidders (one per caller) per virtual auction room relaying the bids and auction status between the caller and the virtual auctioneer. A proxy bidder may act automatically to carry out a caller's bidding instructions. These could include “Bid up to £x as necessary” (Ebay Proxy Bid concept). Output would be both to the auction engine and also to an excitement generator which causes the voice style to increase tension in the bidding process. At the end of an auction the proxy informs the caller of the outcome and helps with payment (e.g. PayPal). The proxy may also advise callers on other items after the auction ends. This could be in the event of winning or losing an item. All information available from web would be read out to caller (e.g. seller details and rating)
   d. Multiple virtual commentators (one per caller) per virtual auction room relaying the auction status back to the caller.
3. Central database. Most persistent and volatile information is stored in a centrally accessible database. This is the ‘memory’ of the system.
4. Administration Gateway(s) this allows users to register with the system and subsequently configure their settings and review their previous interactions with the system.

Typical Output Data and Events From a 3rd Party Auction System

These are intended as examples of the sort of information and events that the telephone interface might receive and the sort of actions that may result.

Data for Buyers
Given a specific buyer, determine the list of items they are currently bidding for or which they are interested in making a bid for.
For a given item, determine the number of bidders, the current price, minimum next bid price, closing time for the auction.
For a given bidder, determine the personal status of that bidder (e.g. their peer rating, geographical location).

Events Relevant to Buyers
Outbid Notification—this would typically Indicate the item on which the buyer was outbid, current price, minimum next bid, number of bidders so far. Such events would result in telephone bidders being given an update and encouraged to bid again. Highest bidder would be told they are the leading bid at present. It would also be used to track the number of bidders, which would in turn be used by the system to help set the pace of the auction.
Auction Close Notification—this would typically include identification as to who won and the final price. All bidders on the phone would be told the outcome.

Events Relevant to Sellers
Latest bidder for an item
Auction close

What is claimed is:

1. Control apparatus for an electronic auction system comprising, a telephony interface for connection to a voice or data an auction interface for connection to an electronic auction system and an auction manager arranged to receive user commands via the telephony interface, to receive auction information via the auction interface, to relay auction information to the telephony interface and to relay user commands to the auction interface.

2. Apparatus according to claim 1, wherein the telephony interface is operable to receive and interpret spoken commands.

3. Apparatus according to claim 1 or claim 2, wherein the telephony interface is operable to receive and interpret DTMF tones.

4. Apparatus according to claim 1, arranged to provide a spoken representation of the current status of an auction including information about third party bids or auction closure as determined by information received via the auction interface, the telephony interface being arranged to relay the spoken representation to users.

5. Apparatus according to claim 4, arranged to provide real time spoken updates of the said current status during a user call.

6. Apparatus according to claim 4, arranged to alter voice pitch and/or word frequency responsive to the frequency of bidding and/or the period of time before closure of an auction as determined by information received via the auction interface.

7. Apparatus according to claim 4, arranged to interrupt spoken sentences with a new sentence responsive to the frequency of bidding and/or the period of time before closure of an auction as determined by information received via the auction interface.

8. Apparatus according to claim 1, further including a reminder system arranged to issue user reminders via the telephony interface.

9. Apparatus according to claim 8, wherein reminders are issued as automatically generated spoken reminders via the telephony interface.

10. Apparatus according to claim 1, further including a database arranged to cooperate with the auction manager to authenticate users.

11. Apparatus according to claim 1, further including an administration gateway arranged to allow remote configuration of the apparatus by a user.

12. A method of interacting with an auction comprising receiving bid commands from a user via a speech or DTMF interface, interpreting the commands, relaying the bid commands to an electronic auction system, receiving auction information from the electronic auction system and relaying auction information back to the user in the form of machine-generated spoken information.

13. A method according to claim 12, further including reminding a user that an auction is about to close.

14. A method according to claim 13, wherein the reminding is carried out using a speech reminder.

15. A method according to claim 12, wherein the user has an account with the operator of the auction interaction method and wherein at least portion of the costs of the reminder paging notice or SMS message is deducted from the account.

16. A method according to claim 12, wherein a portion of the sale price of an auctioned item is paid to the operator of the auction interaction method.

17. A method according to claim 12, wherein at least a portion of the cost of calling the speech or DTMF interface is paid to the operator of the auction interaction method.

18. A method according to claim 12, wherein the user pays a fixed fee for use of the interaction method.

19. A computer program which when operated on suitable hardware causes the hardware to be operable to receive bid commands from a user via a speech or DTMF interface, interpret the commands, relay the bid commands to an electronic auction system, receive auction information from the electronic auction system and to relay auction information back to the user in the form of machine-generated speech.

20. A method of generating revenue from an auction comprising providing a real-time telephony interface to an electronic auction which accepts spoken and/or DTMF commands and charging the auction provider and/or auction user for the provision of the voice or DTMF connection.
